(19) United States
(12) Patent Application Publication
(10) Pub. No.: US 2011/0208583 A1
(43) Pub. Date: Aug. 25, 2011

(54) ADVERTISING CONTROL SYSTEM AND METHOD FOR MOTION MEDIA CONTENT

(75) Inventor: Gunnar Trosso, Stockholm (SE)

(73) Assignee: BRIXGATE COMMUNICATION AB, Stockholm (SE)

(21) Appl. No.: 13/125,855

(22) PCT Filed: Dec. 12, 2008
(86) PCT No.: PCT/SE2008/051449

§ 371 Date: Apr. 25, 2011

Related U.S. Application Data
(60) Provisional application No. 61/108,185, filed on Oct. 24, 2008.

(51) Int. Cl. G06Q 30/00

(52) U.S. Cl. 705/14.49

(57) ABSTRACT

Advertising control system and method for motion media content, wherein the advertising control system is connectable to a screen for displaying motion media content, including: at least one positioning database including frame identification data of a motion media content represented in a plurality of frames identified by the frame identification data, wherein at least one frame of the motion media content is connected with position information about product placement, a frame identifier unit configured to identify the at least one frame which is connected with position information about product placement in the positioning database, and a control element configured to link product placement identification data connected to the positioning information, associated with the identified frame, in the positioning database with at least one service action and to display the service action on a screen connectable to the control system.

### FIELD OF THE INVENTION

The present invention relates to an advertising control system for motion media content and a method for controlling advertising in motion media content. The present invention further relates to a computer program for performing the method according to the invention, and a computer readable medium.

### BACKGROUND OF THE INVENTION

It is expensive for the advertisers to advertise during films, and it is hard to show if the advertising actually had the desired effect. There are two traditional ways to expose brands or products within motion media.
Regular commercial breaks interrupting the film.
Product placement within the film

There is no reliable way for advertisers to know how many consumers that were actually attracted by the commercials, and if the attraction resulted in a further (commercial) action. Regular commercials breaks are forced to consumer without regards to interests, which results in higher costs per presumptive consumer for advertisers. In addition, many consumers are tired of having commercials interrupting their film.

The published patent application US 2008/0195468 discloses a method and system where streaming content is combined with advertising using an ad selection and insertion application. The method and system make it possible to personalize ads for users based on viewing history.

The phenomena product placement has since a long time been a way to expose products in the forum motion pictures and is more or less sublime. A great number of motion pictures are partly financed by this indirect advertising method.

One problem connected with motion pictures is that many consumers are illegally downloading the films over Internet. Alterations in the law have been insufficient to prevent this illegal downloading. The film producers have difficulties to generate relevant revenues to make film projects bear their expenses, because of losses from film piracy.

### SUMMARY OF THE INVENTION

The object of the present invention is to solve at least some of the above-mentioned problems and to achieve a higher commercial value for the phenomena product placements to the advertisers. A further aim of the invention is to obtain a pleasing way to expose products and brands to presumptive consumers by selective interactions.

The above-mentioned object is achieved by an advertising control system for motion media content, wherein the advertising control system is connectable to a screen for displaying motion media content. The system comprises at least one positioning database comprising frame identification data of a motion media content represented in a plurality of frames identified by the frame identification data, wherein at least one frame of the motion media content is connected with position information about product placement. The system further comprises a frame identifier unit configured to identify the at least one frame which is connected with position information about product placement in the positioning database, and a control means configured to link product placement identification data connected to the positioning information, associated with the identified frame, in the positioning database with at least one service action, and to display the service action on a screen connectable to the control system.

The present invention further embraces an advertising control method for motion media content, comprising the steps of identifying a frame of a motion media content with a frame identifier unit configured to identify the at least one frame which is connected with position information about product placement in a positioning database, wherein the positioning database comprises frame identification data of a motion media content represented in a plurality of frames identified by the frame identification data, wherein at least one frame of the motion media content is connected with position information about product placement. The method further comprises the steps of linking product placement identification data connected to the positioning information associated with the identified frame in the positioning database, with at least one service action, with a control means, and displaying the service action on a screen connectable to the control system.

The advertising control system and method makes it possible for consumers to interact with content in motion media, e.g. product placements, to obtain further information etc about the products.

In a further embodiment the motion media is film that is legally streamed over Internet. The product placement in the films and the functionality of the commercial actions in the present invention are leading towards making it possible to free of charge stream (or download) film without regular forced commercial beaks.

With the digital technology of today there are possibilities to render product placements more effective in streaming content. The advertising control system, also hereinafter called ICPS (interactive commercial position system), includes a new advertising tool to actively extract potential consumers by supplying linkable product placement or advertising elements. ICPS makes it possible for the consumers to self actively seek or take part of the advertising that the consumer finds interesting, in contrast to regular advertising brakes. The advertiser obtains a direct connection to potential consumers by the linkable (ICPS) advertising in the film.

The advertising control system and method makes it possible for the consumer (the user) to actively search by himself and take part of the information that the consumer finds interesting, in contrast to regular commercial brakes. The advertiser gets a direct connection to potential consumers by the linkable advertising (product placement) in the movie.

The purpose and goal with ICPS
To create prerequisite for viewers to see commercial supported content without regular advertisement breaks.
To implement a tool for advertisers that generates access to potential consumers from earlier non-interactive commercials in streaming motion media.

By having consumers interacting with the product placement, it is possible to calculate how many consumers watching the film that were attracted to a certain product.

### SHORT DESCRIPTION OF THE APPENDED DRAWINGS

FIGS. 1-3 show an exemplary use of the present invention.

FIG. 4 shows the different parts of the advertising control system according to one embodiment of the invention.

FIG. 5 illustrates a positioning database and an identified frame according to one embodiment of the present invention.

FIG. 6 illustrates a service database and a linked product placement identification data according to one embodiment of the present invention.

FIG. 7 shows a flowchart describing the advertising control method according to one embodiment of the present invention.

### DETAILED DESCRIPTION OF PREFERRED EMBODIMENTS OF THE INVENTION

The expression motion media content refers to any kind of motion media that is carried on any kind of physical carrier, digitally streamed or downloaded from the Internet or the telecommunication net, and that is digitally playable on an operating system based unit. The unit preferably has streaming means for streaming a digitally media content, and also a net tracking application.

The system according to the invention is in most cases in the description exemplified with streamed motion media. It is thus possible to use the technology also in conjunction with motion media on a physical carrier, e.g. with motion media on a DVD, a portable memory or downloaded motion media, e.g. EST—Electronic Sales Through etc. One important thing is then that the motion media on the physical carrier is used/played in an operating system based unit. An operating system based unit may be e.g. a window media player, a flash player, a computer or other kind of unit that includes an operating system environment.

If a consumer e.g. downloads a film or plays a DVD in an operating system based unit, the operating system based unit may include the technology, i.e. the system, method and computer program, according to the invention, or the technology may be downloaded from the Internet (if a connection exists). If the operating system in connected to Internet it is possible to link the consumer to different web pages by the different service actions in a service database, and also to update information in the databases.

When a consumer is attracted to something in a motion media content, e.g. a product placement or a commercial, the system according to the invention permits the consumer to pause the film to allow the consumer to interact with the system.

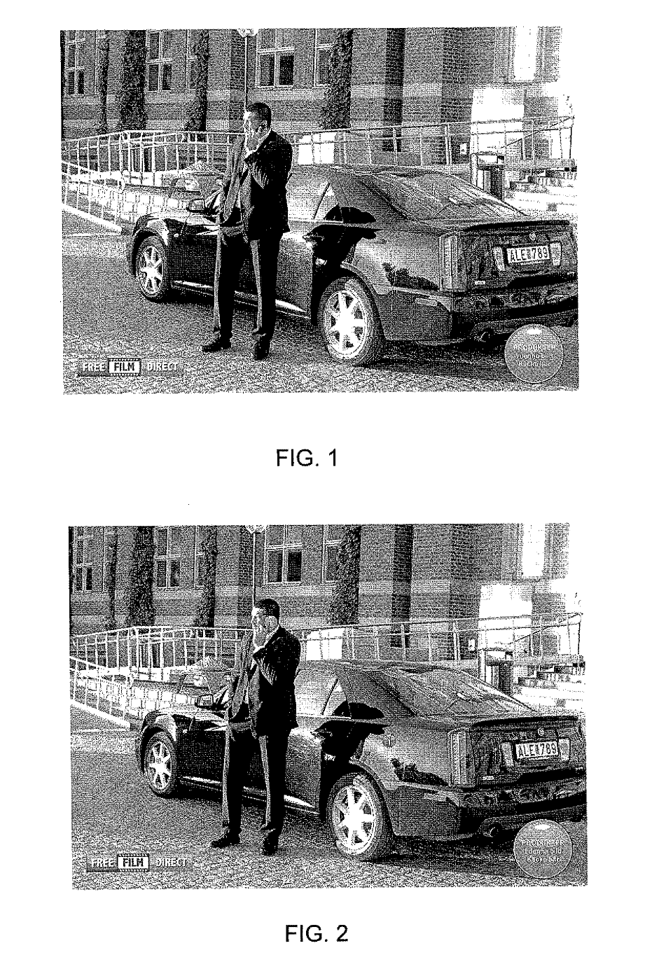

The FIGS. 1 to 3 show an example how the present invention is used to create active interaction between a consumer and product placements in motion media content, e.g. streamed film.

When the consumer pauses the film when he or she discovers an interesting product in a frame shown to the consumer of the paused film, the system provides information about which products that are accessible in the frame. According to one embodiment the system now generates an icon in the frame as can be seen from FIG. 1. To show which products in the frame it is possible to get more information about, the consumer performs a consumer action rendering an input action to the operating system, e.g. clicks on the generated icon furthest down to the right in FIG. 1, here with the text “Products in this picture. Click here”. This consumer action may be any kind of input-action performed by the consumer, e.g. the consumer uses a laser pen, a touch on a touch screen, a press on the keyboard, a “click” with the mouse etc. The consumer action results in that the operating system gets information about one or several coordinates on the screen to be able to distinguish a certain area e.g. a button/box/icon/product in the frame. The coordinates may be vector-based or pixel-based.

When the consumer performs an input action to the operating system, the system marks all interactive product placed objects with a small information icon, as can be seen from FIG. 2. The consumer clicks on, or otherwise makes an input action associated with the desired marked product to the system, wherein the desired product now is provided with an icon to obtain more information.

The consumer thus interacts with the system by making an input action to the operating system, e.g. clicking with the pointing tool in the frame displaying the motion media content, e.g. streamed film. Accordingly, the consumer himself controls (interacts) which information or service in the system the consumer wants to gain more access to.

The system then presents information about the product (in this case a car), which is selected by the consumer by the consumer action, in the frame, as can be seen from FIG. 3. The system also handles forwarding of the consumer to the advertisers Internet portal for campaign offers or to conduct direct purchases. In the above mentioned case the advertiser offers the consumer to search and link to a geographically close local retailer. The location of the consumer may be linked to the IP-number of the operating system based unit of the consumer, or any kind of other information identifying a location of the consumer.

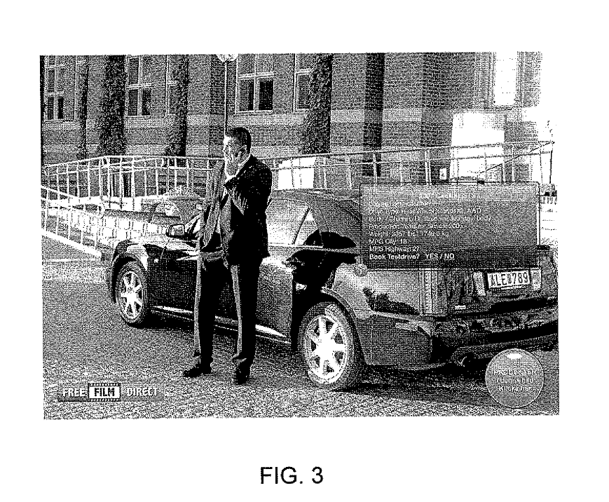

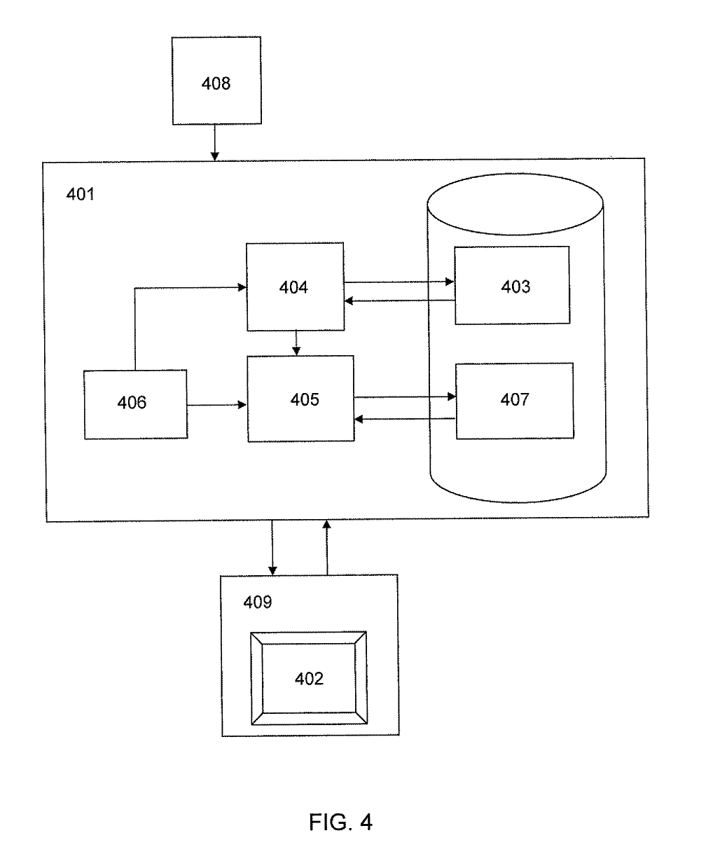

A structural embodiment of the present invention is now described in conjunction with FIG. 4. The advertising control system 401 according to the invention is intended to be used with motion media content. The system 401 is connectable to a screen 402, for displaying the motion media content, wherein the screen 402 is connected to an operating system based unit 409. The system 401 further comprises at least one positioning database 403 comprising frame identification data (see FIG. 5, column B) of a motion media content represented in a plurality of frames identified by the frame identification data. The motion media content thus comprises a plurality of subsequently following frames (see FIG. 5, A), and the frames may all be identified by unique identities for this particularly motion media content. The at least one frame of the motion media content is connected with position information about product placement in the positioning database 403. A frame is one of many single images in a motion media content, e.g. a film, a video, an animation and related fields.

The positioning database 403 is according to one embodiment built up of posts (see column B in FIG. 5) enumerated after the number of frames in the motion media content, e.g. a film. The building-up process of the database may be made by hand or automatically by going through the motion media content and for every frame the number of linkable objects (e.g. product placements or other kind of objects, see column C and E in FIG. 5) and their position (see column D and E in FIG. 5) are recorded in the positioning database.

For example, a normal playtime for a film is 90 minutes. A film that contains 25 pictures (frames) per second gives about a post address interval of the database being about (90 minutes×60 seconds×25 pictures) 135 000 addressable data posts. For frames without linkable information no information other than numbers for the film frame “frame identification data” (column B in FIG. 5) is stored.

If the motion media content is downloaded or is carried on a physical carrier, a calibration process between the motion media content and the position database may be needed, to achieve correct linking between the positioning database 403 and the motion media content.

The system may use several databases of the positioning database-type. The positioning database of the system may according to one embodiment comprise several databases. The positioning database 403 is also called commercial positioning database, abbreviated CPD. A CPD is a database for the respective motion media content that contains linkable objects (Commercials). The linkable objects may be objects in the film or objects in a commercial that runs e.g. before the film. The objects may be product placements, but may also be other kinds of objects that a consumer finds appealing and wants to have more information about.

A frame identifier unit 404 is configured to identify the at least one frame in the motion media content (A, FIG. 5) which is connected with position information (column D, F, FIG. 5) about product placement in the positioning database 403. Further is a control means 405 configured to link product placement identification data (column C, E, FIG. 5) connected to the positioning information, associated with the identified frame, in said positioning database 403 with at least one service action and to display the service action on a screen 402 connectable to the advertising control system 401. The frame identifier unit 404 and control means 405 comprises according to one embodiment processing means to enable their functionality.

Preferably, each motion media content is connected to a separate positioning database 403.

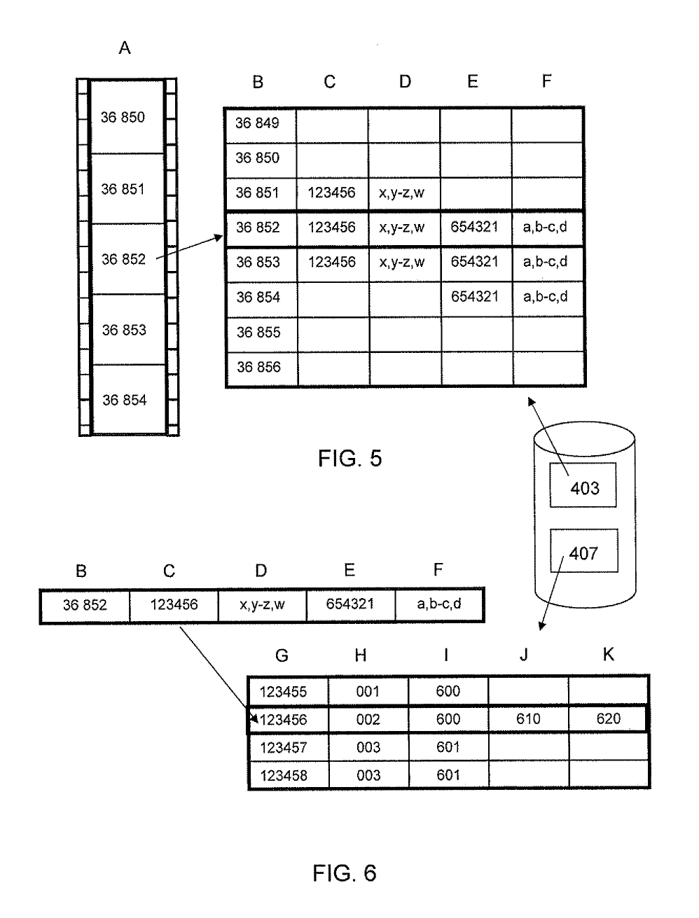

When the consumer pauses the motion media content, in this case film A, the motion media content is stopped in a specific frame and the system reads the position of the streamed film, i.e. the frame identifier unit 404 identifies the frame of the media content. Advantageously, the advertising control system 401 according to the invention comprises receiving means 406 for receiving an indication that the motion media is paused. In the example illustrated in the FIGS. 5 and 6, the film has been stopped in frame 36 852.

According to one embodiment, the system 401 comprises processing means to compares motion media content identification, e.g. the film title, with advertising control system activation data on a database. If the current title is identified as having an accompanying positioning database 403, the frame identifier unit 404 identifies a frame of the media content.

According to the invention, a control means 405 is adapted to generate an information icon and to display the information icon on the screen 402 connected to the system if said positioning database 403 includes positioning information about product placements. The system thus identifies if the paused frame contains linkable objects. If the frame contains linkable objects, the system generates an information icon, here a clickable icon, see FIG. 1. If the data post is “No stored information” or other data indicating that the data post does not comprises relevant information, then no icon is shown.

In one embodiment according to the invention, the control means 405 is adapted to generate an icon for every product placement in the identified frame and displays the icon(s) on the screen 402 connected to the system. Thus, every product placement that is connected to linkable information is identified and shown to the consumer.

The control means 405 is according to one embodiment adapted to retrieve the service action from a service database 407. Accordingly, it is possible to have a database structure that facilitates the management of the different services actions connected to a product placement. Preferably, the service database 407 includes several service actions connected to the same product placement identification data. It is thus possible to have several subsequent service actions connected to one product placement making it possible for an advertiser to show a plurality of service actions for a consumer. This service database 407 may contain all the registered linkable objects in the system, i.e. all product placement identification data, and the connected service action(s), that is to be generated to the consumer.

Advantageously, the system further comprises receiving means 406 for receiving consumer action positioning data indicating a position of a consumer action on said screen. Thus, according to one embodiment, when the consumer makes an input action to the system rendering position data to the system in the area of the generated information icon, e.g. “clicks” on the icon “information icon”, the system matches the paused frame against frame identification data B in the positioning database 403.

An embodiment of the present invention is now described in conjunction with FIG. 5. The motion media content A has been paused and a frame, here with the number 36 852, is identified. The positioning database 403 is according to one embodiment built up with a column B with posts with frame identification data matching frames of a motion media content A. For the data post in the positioning database 403 with the frame identification data number 36 852 the information is stored for two linkable objects, product placement identification data 123456 and product placement identification data 654321, respectively, in column C and E. The product placement identification data fields may also be called Commercial ID #1 and Commercial ID #2. The post further contains positioning information specified in the fields in column D and F. These columns are also referred to as “Position Area #1” and “Position area #2”. The positioning database 403 is here explained for illustrative purposes, and it is to be understood that the positioning database 403 may be built up in another way. For example, the data posts in the positioning database may be column-based instead of row-based.

The system 401 may theoretically handle a large number of product placements identification data (C, E . . . X) for each frame. The number of linkable objects may thus be limited to a certain number, e.g. 20, in the same frame according to limitations in visual presentation.

In one embodiment, the positioning for the first objects, i.e. the first objects product placement positioning data is specified according to an area of a square with the coordinates x, y for the upper left corner and the coordinates z, w for the lower right corner.

In one embodiment, the positioning for the second object, i.e. the first objects product placement positioning data, is specified according to an area of a square with the coordinates a, b for the upper left corner and the coordinates c, d for the lower right corner.

In a further embodiment, the positioning for an object is specified as a point with the coordinates e, f. It may then be predetermined that a certain area around these coordinates, or point, qualifies as an area where the object is positioned. Accordingly, it is possible to reduce the positioning information that has to be stored. Other methods for obtaining a positioning for an object are of course possible.

FIG. 5 shows that the first linkable object product placement identification data (here 123456, column C) exists in the interval from frame 36 851 to frame 36 853, and that this part of the motion media content it is actually linkable in 3 frames. The other linkable object product placement identification data (here 654321, column E) is in the interval from picture 36 852 to 36 854 and is thus linkable in 3 frames.

According to one embodiment, the control means 405 of FIG. 4 is adapted to generate at least one icon in response to obtaining consumer action positioning data within a certain area or interval. Thus, if a consumer clicks on the “information icon”, he or she may see which product placements in the frame that includes linkable information about the product.

In a further embodiment, the control means 405 is adapted to display at least one service action connected to a product placement identification data on the screen, in response of receiving consumer action positioning data within a certain area or interval. Accordingly, if the consumer clicks within some of the above mentioned product placements positioning data, the connected service action is displayed on the screen 402. The accessible service actions are shown in FIG. 6. For the chosen product placement identification data 123456 there are according to this example three levels, specified in column I-J. The product placement identification data is advantageously only stored as one post in the service database 407. There may of course be an unlimited number of levels of service actions in the database 407.

A consumer may thus obtain service actions, i.e. commercials, connected to a product placement by interacting with the system 401. For example, when the consumer moves the pointer tool over the screen, or in any other way causes an input action rendering a position on the screen to the operating system, the operating system generates a position specified in the coordinates h, v. If the consumer “clicks” when h, v lies in the interval for coordinates specified as product placement positioning data (column E and F) in the database, the system links the accompanying product placement identification data (C, E) to a service action in the service database 407. The product placement positioning data coordinates (column D, F) in the database may thus be a point, and may specify an area around this point.

Advantageously, the control means 405 is adapted to present subsequently following service actions (600, 610, 620) connected to the same product placement identification data (column G) on the screen 402, in response of receiving consumer actions positioning data within a certain area or interval. Accordingly, a consumer may obtain several service actions connected to a product placement, by interacting with the system. The consumer may by a “click”, or any other kinds of input action, in the frame obtain all levels specified in the service database 407. For example, the service actions may be:
Service action I—Information about the product is displayed on the screen 402 via an information box in the picture (see FIG. 3).
Service action J—The system shows a product figure, e.g. a car, telephone etc.
Service action K—Links consumer to a homepage of the advertiser, an advertiser GUI. In this case the control means 405 performs the linking.

If the consumer chooses to not continue after a certain service level, the consumer only presses PLAY and the film continues to be streamed.

The positioning database 403 and the service database 407 can be updated at any time without any interfering at all with the motion media content. This offers a possibility to a high flexibility and instant up to date information to advertising control system supported streamed content.

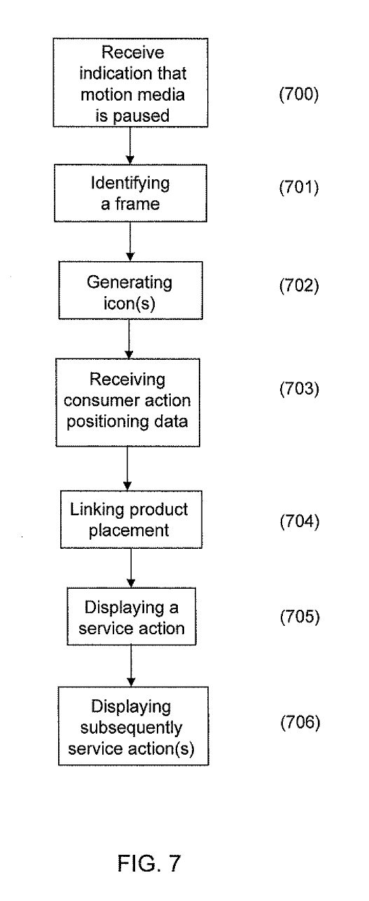

The invention according to the present invention also relates to an advertising control method for motion media content. The method is explained in conjunction with the flowchart shown in FIG. 7.

A consumer starts streaming a motion media content from e.g. a website 408 to an operating system based unit 409. The consumer sees something interesting in the motion media content and preferably pauses the motion media content. The system is then receiving an indication (step 700) to a receiving means 406 that the motion media content is paused.

The method includes, according to one embodiment, the step of comparing motion media content identification, e.g. the film title, with advertising control system activation data on e.g. a database server. If the current title is identified as having an accompanying positioning database 403, the method then comprises the step of identifying (step 701) a frame of the motion media content with a frame identifier unit 404 configured to identify the at least one frame which is connected with position information about product placement in the positioning database 403.

The method further comprises the step of linking (step 704) product placement identification data connected to the positioning information associated with the identified frame in the positioning database 403, with at least one service action, with a control means 405, and finally displaying (step 705) the service action on a screen 402 connectable to the control system.

According to the method, the current frame number in the film is matched to a data post in the accompanying positioning database 403 on the database server, see FIG. 5. If the matching data post contains information in data field “C”, the current frame contains positioning information about product placements and the system generates an information icon (step 702), and displays the information icon on the screen, see FIG. 1.

Advantageously, the advertising control method includes the step 703 of receiving consumer action positioning data indicating a position of a consumer action on the screen 402. Accordingly, it is possible to for the consumer to interact with the system to get more information about something in the paused frame that the consumer finds appealing.

According to one embodiment, the system includes the steps of generating an icon for every product placement in the frame and displaying the icon(s) on the screen. Preferably, the system generates icons when the consumer clicks on the above described “information icon” and the system then obtains consumer action positioning data within a certain area or interval and in response generate the icons. The method includes the step of reading positions in question for included product placements positioning data from the data fields D and F in the positioning database 403. The system advantageously generates small icons in the identified frame based on these positioning data, see FIG. 2.

The method according to the present invention preferably comprises the step 705 of displaying the at least one service action connected to a product placement identification data on the screen, in response of receiving consumer action positioning data within a certain area or interval. The method further advantageously comprises the step of retrieving the service actions from a service database 407. The method thus includes the step of matching product placement identification data C, E in the positioning database 403 with product placement identification data G in the service database 407 on e.g. a database server and obtains service actions in column I, J, K . . . X in FIG. 6 belonging to the chosen product/object. In this example, the first service action 600 includes generating a text box with information about the product in the frame, see FIG. 3.

According to one embodiment, the consumer now clicks on one of the generated icons on the screen 402. The control means 405 compares the retrieved consumer action positioning data with the product placement identification data fields (column D and F) of the post and identifies and generates adherent service action to the product placement identification data on the frame. One example of such a service action can be seen from FIG. 3, illustrated as a text box with information about the chosen product and a linkable offer. The displayed service action may be at least one of the actions to show a text in a picture, to link to a search portal, to show a product picture or to link to an advertiser GUI. These exemplified service actions should not be seen as limiting, thus there are pluralities of other possible service action within the scope of the claims.

The method may include the step 706 of displaying subsequently following service actions connected to the same product placement identification data on the screen, in response of receiving consumer actions positioning data within a certain area or interval connected to a generated icon. A consumer may for example “click” on the linkable offer as shown in FIG. 3, and then a second service action 610 is displayed to the consumer. Service action 610 may be to show a picture of the chosen product about which the consumer wants to have more information. This displayed service action 610 may also give access to another service action 620, e.g. if the consumer clicks on the displayed service action 610. If service action 620 is activated, the method is linking the consumer to e.g. a homepage of the advertiser. The consumer may be directed to a retailer in the neighbourhood of the consumer, and to localize a retailer close to the consumer the system according to one embodiment uses the IP-number of the operational system based unit of the consumer by a suitable application, for example the Player Geotracking. This is a standard application for IP number location, and is not further described in the application. Another possibility of retrieving a consumer's location is by GPS.

Advantageously the system registers and stores all information flows and interactions that are activated by a consumer. The stored information forms a base for statistical analysis and debiting of advertisers or other cooperating partners with linkable objects. For example may an advertiser identification data (column H, FIG. 6) be used to keep track on the service actions connected to the advertiser.

According to one embodiment, the control means 405 is adapted to register and store information flows activated by the consumer. Thus, it is possible to get statistics of how a consumer has been interacting with the system. The system may generate statistics as:
The number of films accounted per title, point of time and playing time.
The number of activated interactions per product placement identification data and to which levels, 600, 610, 620 . . . etc.
Point of time and date for all interactions per product placement identification data.
Geographic distribution by IP-number, Geotracking application.
The number of product placement identification data per advertiser (001 . . . XXX, see FIG. 6, H) in combinations with the above.

These statistics are important data to use and show how the system may commercially finance the moveable streamed material, e.g. film. A great advantage for the advertiser is that he only pays for actively potential consumers. The system offers alternative advertising income without regular advertising breaks for uninterested consumers.

The system according to the invention further comprises at least one computer program comprising computer readable code means which, when run on an operating system based unit, causes the operating system to perform the method steps for controlling advertising in motion media content as described above. The present invention may further include a computer readable medium on which is stored computer readable code means which, when run on an operating system based unit, causes the operating system to perform the method for controlling advertising in motion media content as described above. Accordingly, the system preferably comprises code to control and transfer the information flows in internal and external modules as media players, operating systems, graphic user interfaces and databases (internal and on CDN, Content Delivery Network).

The present invention is not limited to the above-described preferred embodiments. Various alternatives, modifications and equivalents may be used. Therefore, the above embodiments should not be taken as limiting the scope of the invention, which is defined by the appending claims.

1-27. (canceled)

28. Advertising control system for motion media content, wherein the advertising control system (401) is connectable to a screen (402) for displaying motion media content, comprising:
at least one positioning database (403) comprising frame identification data of a motion media content represented as a plurality of frames identified by the frame identification data, wherein at least one frame of the motion media content is connected with position information about product placement,
a frame identifier unit (404) configured to identify the at least one frame which is connected with position information about product placement in said positioning database, and
a control means (405) configured to link product placement identification data connected to the positioning information, associated with said identified frame, in said positioning database with at least one service action and to display said service action on a screen (402) connectable to the control system, wherein the control means (405) is adapted to retrieve the service action from a service database (407), said service database (407) is further adapted to include several subsequent service actions connected to the same product placement identification data,
a receiving means (406) for receiving an indication that the motion media is paused, the system is further adapted to provide information about which products that are accessible in the frame when said motion media is paused.

29. Advertising control system according to claim 28, wherein the control means (405) is adapted to generate an information icon and displays said information icon on said screen (402) if said positioning database (403) includes positioning information about product placements.

30. Advertising control system according to claim 28, wherein said control means (405) is adapted to generate an icon for every product placement in said identified frame and displays said icon(s) on the screen (402).

31. Advertising control system according to claim 28, wherein the receiving means (406) for receiving consumer action positioning data further indicates a position of a consumer action on said screen (402).

32. Advertising control system according to claim 28, wherein said control means (405) is adapted to generate at least one icon in response to obtaining consumer action positioning data within a certain area or interval.

33. Advertising control system according to claim 28, wherein said control means (405) is adapted to display said at least one service action connected to a product placement identification data on said screen (402), in response of receiving consumer action positioning data within a certain area or interval.

34. Advertising control system according to claim 28, wherein said control means (405) is adapted to display subsequently following service actions connected to the same product placement identification data on said screen (402), in response of receiving consumer actions positioning data within a certain area or interval.

35. Advertising control system according to claim 28, wherein said service actions is at least one of the actions to show a text in a picture, to link to a search portal, to show a product picture or to link to an advertiser GUI.

36. Advertising control system according to claim 28, wherein each motion media content is connected to a separate positioning database (403).

37. Advertising control system according to claim 28, wherein said frame identifier unit (404) and control means (405) comprises processing means.

38. Advertising control system according to claim 28, wherein the system (401) is adapted to register and store information flows activated by the consumer.

39. Advertising control method for motion media content, comprising the steps of:
receiving an indication to a receiving means that a motion media content is paused;
identifying a frame of said paused motion media content with a frame identifier unit (404) configured to identify the at least one frame which is connected with position information about product placement in a positioning database (403), wherein the positioning database (403) comprises frame identification data of a motion media content represented as a plurality of frames identified by the frame identification data, wherein at least one frame of the motion media content is connected with position information about product placement;
linking product placement identification data connected to the positioning information associated with said identified frame in said positioning database, with at least one service action from a service database (407) adapted to include several subsequent service actions connected to the same product placement identification data, with a control means (405); and
displaying said service action on a screen (402).

40. Advertising control method according to claim 39, including the steps of generating an information icon and displaying said information icon on said screen if said positioning database (403) includes positioning information about product placements.

41. Advertising control method according to claim 39, including the steps of generating an icon for every product placement in the frame and displaying said icon(s) on the screen (402).

42. Advertising control method according to claim 41, including the step of receiving consumer action positioning data indicating a position of a consumer action on said screen (402).

43. Advertising control method according to claim 42, including the steps of obtaining consumer action positioning data within a certain area or interval and in response generating said icons.

44. Advertising control method according to claim 43, including the step generating at least one icon in response to obtaining consumer action positioning data within a certain area or interval.

45. Advertising control method according to claim 43, including the step of displaying said at least one service action connected to a product placement identification data on said screen (402), in response of receiving consumer action positioning data within a certain area or interval.

46. Advertising control method according to claim 45, including the step of displaying subsequently following service actions connected to the same product placement identification data on said screen (402), in response of receiving consumer actions positioning data within a certain area or interval.

47. Advertising control method according to claim 39, including the step of displaying service actions being at least one of the actions to show a text in a picture, to link to a search portal, to show a product picture or to link to an advertiser GUI.

48. A computer program comprising computer readable code means which, when run on an operating system based unit, causes the operating system to perform the method for controlling advertising in motion media content according to claim 39.

49. A computer readable medium on which is stored computer readable code means which, when run on an operating system based unit, causes the operating system to perform the steps of a method for controlling advertising in motion media content according to claim 39.
